(19) United States
(12) Patent Application Publication
(10) Pub. No.: US 2008/0133056 A1
(43) Pub. Date: Jun. 5, 2008

(54) ROBOT SYSTEM

(75) Inventor: Yasunori Nishihara, Gotenba-shi (JP)

Correspondence Address: DLA PIPER US LLP, P. O. BOX 9271, RESTON, VA, 20195, US

(73) Assignee: TOSHIBA KIKAI KABUSHIKI KAISHA, TOKYO-TO (JP)

(21) Appl. No.: 11/873,044

(22) Filed: Oct. 16, 2007

(30) Foreign Application Priority Data
Oct. 17, 2006 (JP) 2006-282641

(51) Int. Cl. B25J 9/04

(52) U.S. Cl. 700/254; 700/245; 901/2; 901/16; 901/30

(57) ABSTRACT

The present invention provides a robot system which can move a robot hand with ease and enable fine adjustment, as well as can prevent collision of the hand with surrounding structures. In this invention, a robot system 10 includes a robot body 11 and a control section 20 for controlling the robot body 11. The robot body 11 includes a first hand 12, a J1 axis along which the first hand 12 is driven in a direction defined from a proximal end 12a of the first hand 12 to its distal end 12b, a J4 axis about which the J1 axis is rotated in a horizontal plane, a J3 axis along which the J4 axis is shifted in the vertical direction, and a J5 axis along which the J3 axis is shifted in a direction in a horizontal plane. The J1 axis, J3 axis, J4 axis and J5 axis are synchronously driven by the control section 20, whereby the first hand 12 can be moved on the X axis, Y axis and C axis in a tool coordinate system, on the basis of the center of the first hand 12.

### CROSS REFERENCE TO PRIOR APPLICATION

This application claims priority from Japanese Patent Application No. 2006-282641 filed on Oct. 17, 2006. The entire contents of this application are incorporated herein by reference.

### BACKGROUND OF THE INVENTION

1. Field of the Invention

The present invention relates to a robot system including a robot body and a control section for controlling the robot body, and in particular to a robot system for use in carrying glass, wherein a hand of its robot body can be moved along the X axis, Y axis and C axis of a tool coordinate system, on the basis of the center of the hand, upon a manually guided operation.

2. Background Art

As shown in FIG. 9, a glass carrying robot system 6 generally includes a robot body 1 and a control section 5 for controlling the robot body 1. The robot body 1 has a first hand 2 and a second hand 3 constituting a pair together with the first hand 2. Each of the hands 2, 3 is for placing a glass substrate thereon and carrying it to a desired place.

The robot body 1 has five axes for driving the first hand 2 and second hand 3. These five axes include a J1 axis along which the first hand 2 is moved in a direction from its proximal end 2a to its distal end 2b, a J2 axis along which the second hand is moved in a direction from its proximal end 3a to its distal end 3b, a J4 axis about which the J1 axis is rotated in a horizontal plane, a J3 axis along which the J4 axis is shifted in the vertical direction, and a J5 axis along which the J3 axis is reciprocated in a direction in a horizontal plane.

As shown in a skeleton illustration of FIG. 10, when viewing the robot body 1 from above, the J1 axis and the J2 axis are arranged on a same straight line in the XY plane of a world coordinate system (fixed coordinate system). Namely, the first hand 2 is located above the second hand 3, such that each glass substrate can be carried more efficiently, by operating the first hand 2 together with the second hand 3.

The robot body 1 is configured to be driven, by a manually guided operation as well as by a programmed operation, due to a sigmoid adjustable-speed operation (an operation in which the driving speed is gradually increased with a positive acceleration, followed by gradually decreasing the speed with a negative acceleration until stopping the operation), based on an articulation coordinate system (or coordinate system comprising the J1 axis to J5 axis) or the world coordinate system (or fixed coordinate system). For example, the robot body 1 can raise or lower the first hand 2 along the J3 axis in the articulation coordinate system, and move the second hand 3 linearly along the X axis in the world coordinate system. As used herein, the term “manually guided operation” refers to a work for teaching the robot body 1, such as a work for operating the robot body 1 by manipulating a teaching pendant due to an operator. Meanwhile, the programmed operation refers to a work for operating the robot body 1, based on an operating procedure programmed in the control section.

Conventionally, in the case of guiding the robot body 1 by the manually guided operation, it is common to guide it along each axis of the articulation coordinate system. However, in the case of guiding the robot body 1 along each axis of the articulation coordinate system, it can be operated only along or about the axes J1 to J5. Thus, this method is not suitable for finely adjusting the position of each hand 2, 3 of the robot body 1, at the distal end of each hand 2, 3.

For example, assume that the first hand 2 of the robot body 1 is positioned to be slightly oblique relative to a glass substrate storage portion 4, as shown in FIG. 11(a), and assume that it is necessary to insert the first hand 2 straight relative to the glass substrate storage portion 4, as shown in FIG. 11(b). In such a case, if advancing the first hand 2 along only the J1 axis of the articulation coordinate system, the first hand 2 may tend to collide with a side wall 4a inside the glass substrate storage portion 4.

Accordingly, in order to prevent such a collision and insert the first hand 2 straight relative to the glass storage portion 4, it is necessary to advance the first hand 2 toward the glass storage portion 4, while slightly shifting the J1 axis, J4 axis and J5 axis of the articulation coordinate system, in the directions designated by arrows respectively illustrated in FIG. 11(b), However, such a work for guiding the first hand 2 along the respective axes of the articulation coordinate system is quite difficult and complicated. In addition, there is greater risk to make the first hand 2 collide with surrounding structures, by mistake, during the work.

### SUMMARY OF THE INVENTION

The present invention was made in light of the above circumstances, and it is therefore an object of this invention to provide a glass carrying robot system, wherein a hand of its robot body can be moved along the X axis, Y axis and C axis of a tool coordinate system, based on the center of the hand, upon a manually guided operation.

A first aspect of the present invention is a robot system including a robot body and a control section for controlling the robot body, the robot body comprising: a first hand and a J1 axis, a J3 axis, a J4 axis, and a J5 axis along which the robot body is driven, wherein; the J1 axis is an axis along which the first hand is moved in a direction from a proximal end of the first hand to its distal end; the J4 axis is an axis about which the J1 axis is rotated in a horizontal plane; the J3 axis is an axis along which the J4 axis is shifted in the vertical direction; and the J5 axis is an axis along which the J3 axis is shifted in a direction in a horizontal plane, wherein the J1 axis, J3 axis, J4 axis and J5 axis are synchronously driven by the control section, whereby the first hand can be moved on the X axis, Y axis and C axis in a tool coordinate system, on the basis of the center of the first hand.

A second aspect of the present invention is a robot system including a robot body and a control section for controlling the robot body, the robot body comprising: a first hand; a second hand constituting a pair together with the first hand; and a J1 axis, a J2 axis, a J3 axis, a J4 axis, and a J5 axis along which the robot body is driven, wherein; the J1 axis and the J2 axis are axes along which the first hand and the second hand are moved in predetermined directions, from proximal ends to distal ends of these hands, respectively; the J4 axis is an axis about which the J1 axis and J2 axis are rotated in a horizontal plane, respectively; the J3 axis is an axis along which the J4 axis is shifted in the vertical direction; and the J5 axis is an axis along which the J3 axis is shifted in a direction in a horizontal plane, wherein the J1 axis, J2 axis, J3 axis, J4 axis and J5 axis are synchronously driven by an operational signal sent from the control section, whereby the first hand and second hand can be moved on the X axis, Y axis and C axis in a tool coordinate system, on the basis of the centers of the first hand and second hand, respectively.

The present invention is the robot system described above, wherein either one of the first hand and second hand, which is located on the distal side relative to the J4 axis, is decided as a current hand, and wherein the decided current hand is moved along the X axis, Y axis and C axis in a tool coordinate system, on the basis of the center of the current hand.

The present invention is the robot system described above, wherein the control section has a function to switch a usual articulation coordinate system mode for the J1 axis, J2 axis, J3 axis, J4 axis and J5 axis and the tool coordinate system mode defined on the basis of the centers of the hands.

The present invention is the robot system described above, wherein the control section has an adjustment function to adjust the tool coordinate system when the center of the hand is offset from the center of a work.

The present invention is the robot system described above, wherein the tool coordinate system is adjusted, based on data concerning the offset amount of the work, the data being registered, in advance, in the control section.

The present invention is the robot system described above, wherein the control section includes an operational mode in which it automatically decides which is to be the current hand, among the first hand and second hand.

The present invention is the robot system described above, wherein the first hand and second hand carry a work comprising a glass substrate, respectively.

The present invention is the robot system described above, wherein the J1 axis and J2 axis are located on a same straight line in the XY plane of a fixed coordinate system, when viewed above the robot body.

The present invention is the robot system described above, wherein the first hand is located above the second hand.

According to the present invention, since the hand can be moved on the X axis, Y axis and C axis of the tool coordinate system, on the basis of the center of the hand, the hand can be operated more easily and enable finer adjustment, upon a manually guided operation. Additionally, collisions of the hand with surrounding structures by mistake can be prevented.

Also, according to the present invention, since the current hand can be moved along the X axis, Y axis and C axis of the tool coordinate system, on the basis of the center of the current hand, collisions of one of the two hands, which is not intended to operate, with surrounding structures by mistake can be prevented, upon the manually guided operation.

Furthermore, according to the present invention, since the control section has a function to switch a usual articulation coordinate system mode for the J1 axis, J2 axis, J3 axis, J4 axis and J5 axis and the tool coordinate system mode defined on the basis of the center of the hands, it is possible to readily switch the operational modes from the usual articulation coordinate system mode to the tool coordinate system mode.

Finally, according to the present invention, since the control section has an adjustment function to adjust the tool coordinate system when the center of the hand is offset from the center of a work, the hand can be moved based on a coordinate system to be defined on the basis of the center of the work.

### BRIEF DESCRIPTION OF THE DRAWINGS

FIG. 1 is a diagram showing a first embodiment of a robot system according to the present invention.

FIG. 2 is a perspective view showing each axis based on a tool coordinate system.

FIG. 3 is a skeleton view showing a translational motion along the X axis, of a hand, in the tool coordinate system.

FIG. 4 is a skeleton view showing a translational motion along the Y axis, of the hand, in the tool coordinate system.

FIG. 5 is a skeleton view showing a translational motion along the C axis, of the hand, in the tool coordinate system.

FIG. 6 is a skeleton view for explaining coordinate transformation from the articulation coordinate system into the tool coordinate system.

FIG. 7 is a diagram showing a second embodiment of a robot system according to the present invention.

FIG. 8 is a diagram showing a third embodiment of a robot system according to the present invention.

FIG. 9 is a diagram showing a conventional robot system.

FIG. 10 is a skeleton view showing the conventional robot system.

FIG. 11 is a skeleton view showing fine adjustment of the hand in the conventional robot system.

### DETAILED DESCRIPTION OF THE INVENTION

### Examples

### First Embodiment

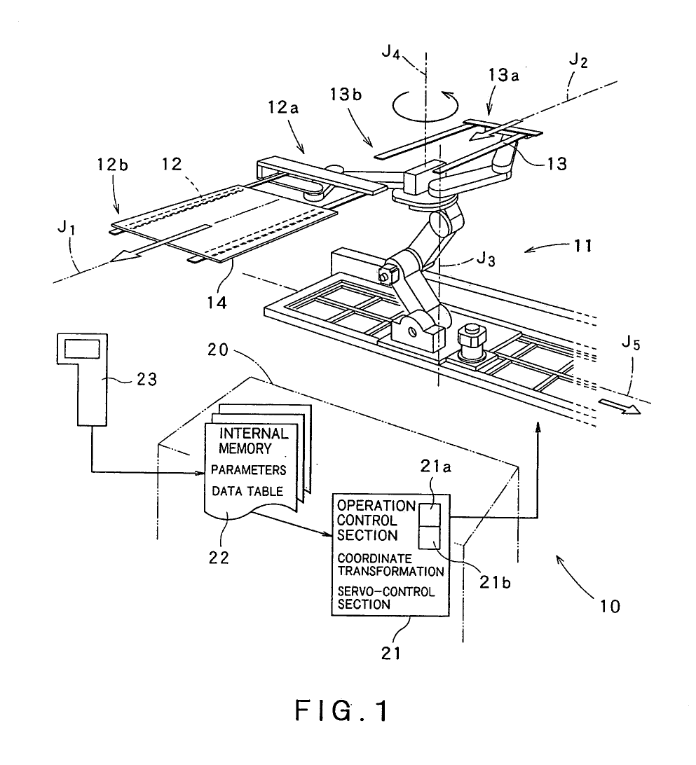

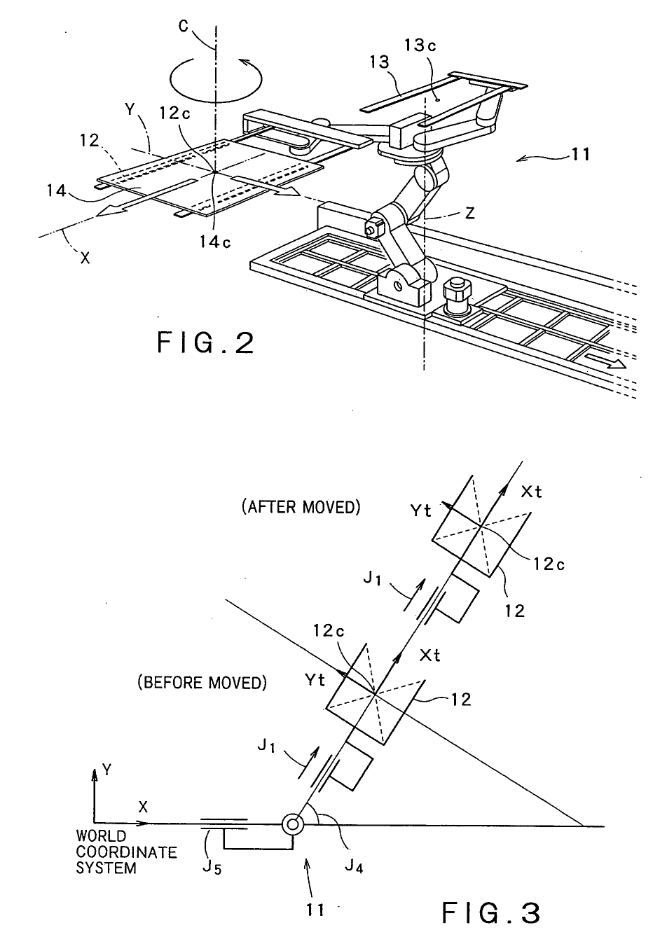

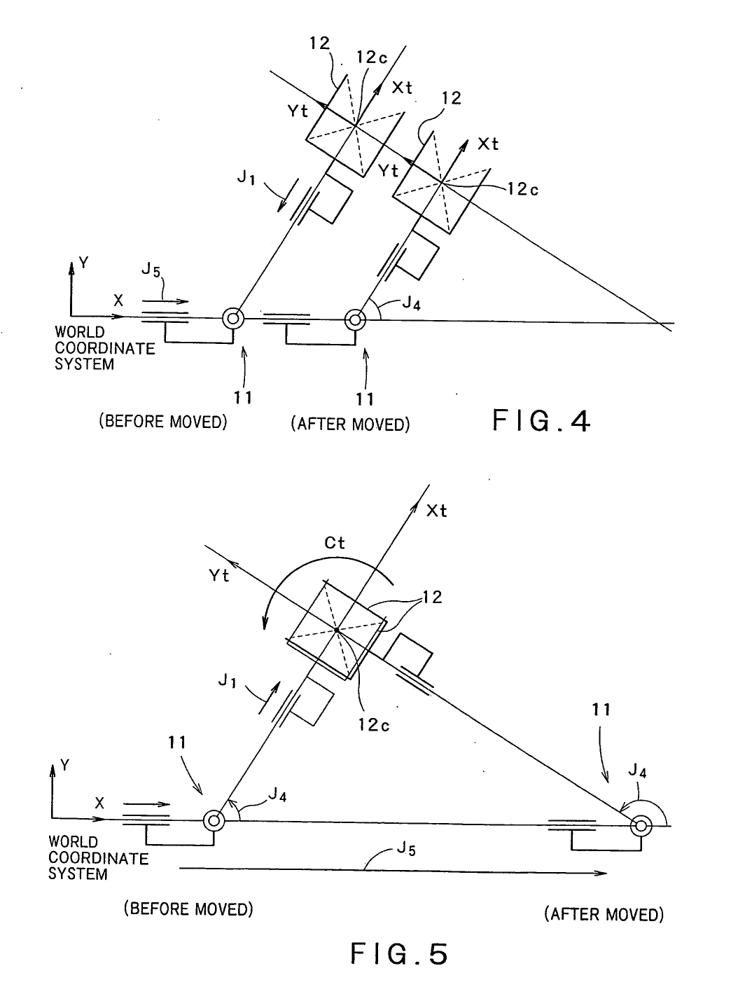

Hereinafter, a first embodiment of the present invention will be described with reference to FIGS. 1 to 5. FIG. 1 is a diagram showing the first embodiment according to the present invention, FIG. 2 is a perspective view showing each axis based on a tool coordinate system, FIG. 3 is a skeleton view showing a translational motion along the X axis of a hand in the tool coordinate system, FIG. 4 is a skeleton view showing a translational motion along the Y axis of a hand in the tool coordinate system, and FIG. 5 is a skeleton view showing a translational motion along the C axis of a hand in the tool coordinate system.

First, referring to FIG. 1, an outline of a robot system according to this embodiment will be described. As shown in FIG. 1, the robot system 10 includes a robot body 11 and a control section 20 for controlling the robot body 11.

The robot body 11 includes a first hand 12 for carrying a work 14 composed of a glass substrate or the like, and a second hand 13 constituting a pair together with the first hand 12.

The robot body 11 has five transfer axes for the articulation coordinate system, i.e., a J1 axis along which the first hand 12 is reciprocated from a proximal end 12a of the first hand 12 to its distal end 12b, a J2 axis along which the second hand 13 is reciprocated from a proximal end 13a of the second hand 13 to its distal end 13b, a J4 axis about which the J1 axis and J2 axis are rotated in a horizontal plane, a J3 axis along which the J4 axis is reciprocated in the vertical direction, and a J5 axis along which the J3 axis is reciprocated in a direction in a horizontal plane.

When viewing the robot body 11 from above, the J1 axis and the 3-2 axis are arranged on a same straight line in the XY plane of the world coordinate system (or fixed coordinate system). Namely, the first hand 12 is located above the second hand 13.

The control section 20 includes an operation control section 21 for directly controlling the robot body 11, an internal memory 22 in which program data and/or parameters to be used for operating the robot body 11 are stored, and a teaching pendant 23 to be used by an operator upon operating the robot body 11. The operation control section 21 includes a servo-control section. Additionally, the control section 20 includes a switching function 21a for switching the articulation coordinate system mode including the J1 axis, J2 axis, J3 axis, J4 axis and J5 axis and the tool coordinate system mode based on the centers 12c, 13c of the respective hands 12, 13.

As shown in FIG. 2, by synchronously driving the J1 axis, J2 axis, J3 axis, J4 axis and J5 axis, due to an operational signal from the control section 20, the first hand 12 can be moved on the X axis, Y axis and C axis, of the tool coordinate system, on the basis of the center 12c of the first hand 12. The first hand 12 can also be moved on the Z axis (the same axis as the J3 axis described above) of the tool coordinate system. In the structure shown in FIG. 2, the center 12c of the first hand 12 is coincident with the center 14c of the work 14.

In the robot body 11, either of the manually guided operation and the programmed operation, due to a sigmoid adjustable-speed operation, can be performed, based on the articulation coordinate system (the coordinate system comprising the J1 axis to J5 axis) or on the world coordinate system (the fixed coordinate system). Besides, the manually guided operation due to the sigmoid adjustable-speed operation can also be performed, based on the aforementioned tool coordinate system.

Completely similar to the above, by synchronously driving the J1 axis, J2 axis, J3 axis, J4 axis and J5 axis, with an operational signal given from the control section 20, the second hand 13 can also be moved along the X axis, Y axis, C axis and Z axis, of the tool coordinate system, on the basis of the center 13c of the second hand 13.

Next, the operation of the embodiment having the construction as described above will be discussed.

Upon a manually guided operation as usual, an operation signal based on the articulation coordinate system mode is sent from the control section 20 to the robot body 11, as such the first hand 12 (or second hand 13) of the robot body 11 is moved along the respective axes J1 to J5, based on the articulation coordinate mode.

Next, an operator utilizes the teaching pendant 23 in order to switch the articulation coordinate system mode into the tool coordinate system mode. In this way, when the control section 20 is switched into the tool coordinate system mode, another operational signal based on the tool coordinate system mode will be sent from the control section 20 to the robot body 11. Thereafter, when the operator uses again the teaching pendant 23, the first hand 12 (or second hand 13) can be moved along the X axis, Y axis, C axis and Z axis, in the tool coordinate system.

Referring now to FIGS. 3 to 5, one specific example will be described for the case wherein the first hand 12 is moved based on the tool coordinate system. It should be appreciated that the description that will be made for the first hand 12 can also be applied to the second hand 13.

First, referring to FIG. 3, the translational motion of the first hand 12 along the X axis in the tool coordinate system will be described. In the case where the first hand 12 is moved in the translational motion along the X axis of the tool coordinate system, the J1 axis of the articulation coordinate system is driven in a direction shown by an arrow. Meanwhile, the J2 axis, J3 axis, J4 axis and J5 axis, of the articulation coordinate system, are not driven, as such the coordinates on these axes are not changed. In this manner, the first hand 12 is moved up to a position after moved from a position before moved, as shown in FIG. 3, in the translational motion, along the X axis of the tool coordinate system.

Next, turning to FIG. 4, the translational motion of the first hand 12 along the Y axis in the tool coordinate system will be described. In the case where the first hand 12 is moved in the translational motion along the Y axis of the tool coordinate system, the J1 axis of the articulation coordinate system is driven in a direction shown by an arrow, while the J5 axis of the articulation coordinate system is driven in another direction shown by another arrow. Meanwhile, the J2 axis, J3 axis and J4 axis, of the articulation coordinate system, are not driven, and thus the coordinates on these axes are not changed. In this manner, the first hand 12 is moved up to a position after moved from a position before moved, as shown in FIG. 4, in the translational motion, along the Y axis of the tool coordinate system.

Referring now to FIG. 5, the rotational motion of the first hand 12 about the C axis in the tool coordinate system will be described. In the case of rotating the first hand 12 about the C axis of the tool coordinate system, the J1 axis of the articulation coordinate system is driven in a direction shown by an arrow, while the J4 axis and the J5 axis of the articulation coordinate system are driven, respectively, along directions shown by other arrows. Meanwhile, the J2 axis and J3 axis of the articulation coordinate system are not driven, and therefore the coordinates on these axes are not changed. In this manner, the first hand 12 is rotated about the C axis of the tool coordinate system, up to a position after moved from a position before moved, as shown in FIG. 5.

Utilizing any suitable combination of the aforementioned operations, the first hand 12 can be optionally moved along the X axis, Y axis and C axis, of the tool coordinate system.

As described above, according to this embodiment, both of the hands 12, 13 can be moved along the X axis, Y axis and C axis, of the tool coordinate system, on the basis of the respective centers 12c, 13c of these hands 12, 13. Therefore, upon the manually guided operation, the hands 12, 13 can be operated with ease for fine adjustment, and collisions of these hands 12, 13 with surrounding structures by mistake can also be prevented.

Additionally, according to this embodiment, the control section 21 includes the switching mechanism 21a for switching the usual articulation coordinate system mode including the J1 axis, J2 axis, J3 axis, J4 axis and J5 axis and the tool coordinate system mode defined on the basis of the centers 12c, 13c of the respective hands 12, 13. Therefore, this embodiment enables a facilitated switching from the usual articulation coordinate system mode into the tool coordinate system mode.

While, in the embodiment described above, the robot body 11 includes the first hand 12 and the second hand 13 constituting a pair together with the first hand 12, the robot 11 may instead include only the first hand 12. Even in such a case, a similar effect to that described above can also be obtained.

### Second Embodiment

Next, a second embodiment according to the present invention will be described with reference to FIG. 7.

FIG. 7 is presented for showing the second embodiment of this invention. The second embodiment shown illustrated in FIG. 7 is different from the first embodiment described above, in that the control section 20 includes an adjustment function 21b for adjusting the tool coordinate system when the center 12c (or the center 13c) of the first hand 12 (or second hand 13) is offset from the center 14c of the work 14. Except this point, however, the construction of the second embodiment is substantially the same as that of the first embodiment. In FIG. 7, like reference numerals denote respectively like parts of the first embodiment shown in FIGS. 1 to 5, and their details will be omitted below.

First, referring to FIG. 7, an outline of a robot system according to the second embodiment will be described. As shown in FIG. 7, the robot system 10 includes the robot body 11 and the control section 20 for controlling the robot body 11. The robot body 11 includes the first hand 12 for carrying the work 14, and the second hand 13 constituting a pair together with the first hand 12. The control section 20 includes the adjustment function 21b for adjusting the tool coordinate system when the center 12c (or center 13c) of the first hand 12 (or second hand 13) is offset relative to the center 14c of the work 14.

Data concerning offset amounts (X, Y) for a plurality of works 14 can be registered in advance in a data base (hereinafter, referred to as a “work offset table”) in the internal memory 22 of the control section 20. Thus, upon the manually guided operation, an optimum offset amount for each work 14 can be selected.

Generally, the works 14 to be carried by the robot body 11 often have various sizes and positions to be placed for each kind of the articles. Therefore, a work offset amount (a distance between the position of the center 12c (or center 13c) of the first hand 12 (or second hand 13) and the position of the center 14c of the work 14) will vary with the kind of each work 14.

Next, the operation of the embodiment having the construction as described above will be discussed.

First, upon the manually guided operation, when an operator manipulates the teaching pendant 23, the articulation coordinate system mode is switched into the tool coordinate system mode. Subsequently, by further manipulation of the teaching pendant 23, the offset amounts (X, Y), concerning a particular work 14 that is about to be carried, are called from the work offset table.

Further manipulation of the teaching pendant 23 can move the first hand 12 (or second hand 13) along the so-offset tool coordinate system. Namely, the first hand 12 (or second hand 13) is moved, based on the tool coordinate system, including the center 14c of the work 14, as the origin.

In this way, according to the second embodiment, when the center 12c (or center 13c) of the first hand 12 (or second hand 13) is offset relative to the center 14c of the work 14, because the control section includes the adjustment function 21b for adjusting the tool coordinate system, the first hand 12 (or second hand 13) can be moved, based on the coordinate system, which is defined on the basis of the center 14c of the work 14.

It is noted that, while, in the embodiment, the robot body 11 includes the first hand 12 and the second hand 13 constituting a pair together with the first hand 12, the robot 11 may instead include only the first hand 12. Even in such a case, a similar effect to that described above can also be obtained.

### Third Embodiment

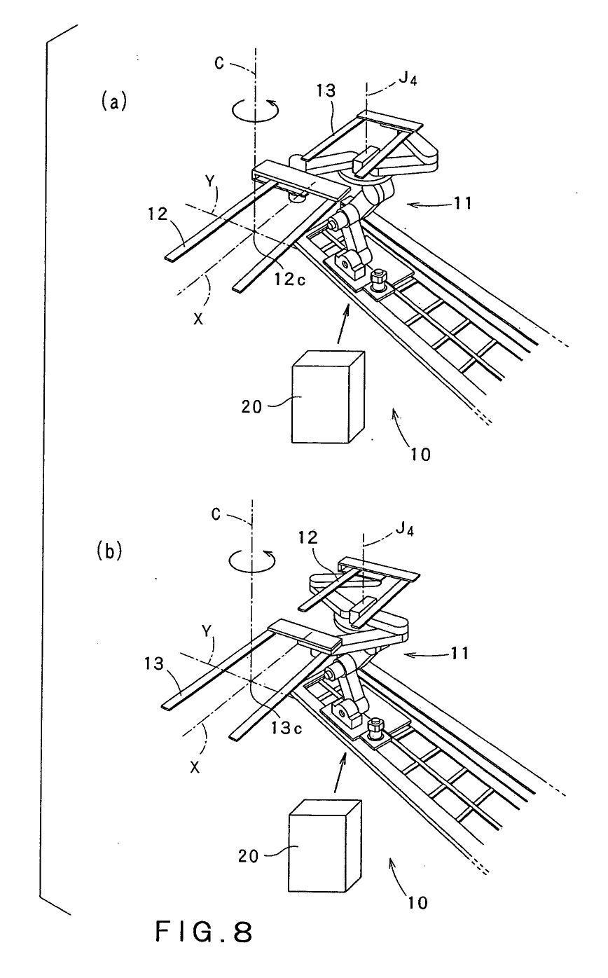

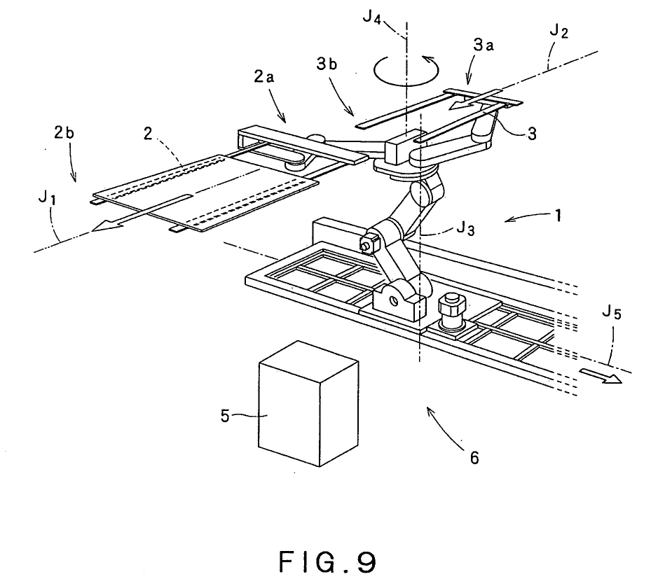

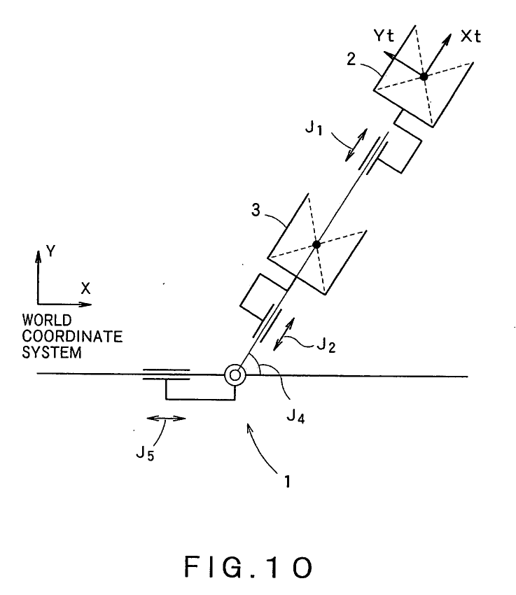

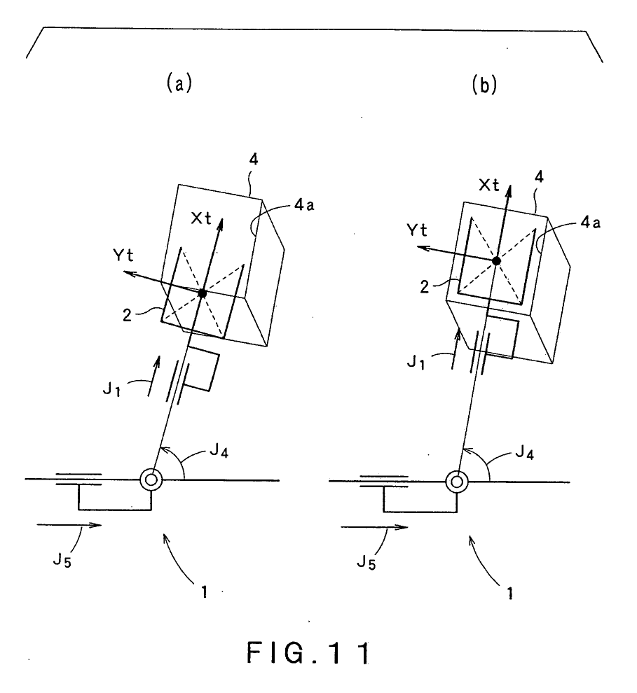

Next, a third embodiment according to the present invention will be described with reference to FIGS. 8(a) and 8(b).

In the drawings, FIG. 8(a) is a diagram showing a case in which the first hand is a current hand, and FIG. 8(b) is a diagram showing a case in which the second hand is a current hand.

The third embodiment shown in FIGS. 8(a) and 8(b) is different from the embodiments described above, in that the center of the current hand is the center of the tool coordinate system. Except this point, however, the construction of this embodiment is substantially the same as the first and second embodiments. In FIG. 8, like reference numerals respectively denote like parts in the first embodiment shown in FIGS. 1 to 5 and those in the second embodiment shown in FIG. 7, and their details will be omitted below.

First, an outline of a robot system according to the third embodiment will be described with reference to FIG. 8. As shown in FIG. 7, the robot system 10 includes the robot body 11 and the control section 20 for controlling the robot body 11. The robot body 11 includes the first hand 12 for carrying the work 14, and the second hand 13 constituting a pair together with the first hand 12.

In this embodiment, either one of the first hand 12 and second hand 13, which is located on the distal side relative to the axis J4, serves as a current hand, wherein the current hand is configured to be moved along the X axis, Y axis and C axis of the tool coordinate system defined on the basis of the center of the current hand. Namely, in the case shown in FIG. 8(a), the first hand 12 serves as the current hand, and the center 12c of the first hand 12 (or current hand) serves as the basis (or origin) of the tool coordinate system. Otherwise, in the case shown in FIG. 8(b), the second hand 13 is used as the current hand, and the center 13c of the second hand 13 (current hand) serves as the basis (or origin) of the tool coordinate system.

As is similar to the second embodiment, the control section 20 may include the adjustment function 21b for adjusting the tool coordinate system, in order to address the case wherein the center 12c (or center 13c) of the first hand 12 (or second hand 13) is offset relative to the center 14c of the work 14.

Next, the operation of the embodiment having the construction as described above will be discussed.

First, upon the manually guided operation, an operator manipulates the teaching pendant 23 in order to switch the articulation coordinate system mode into the tool coordinate system mode. In this case, the control section 20 automatically judges or decides whether the current hand is to be the first hand 12 or the second hand 13. In other words, the control section 20 regards the hand, either one of the first hand 12 and second hand 13, which is located on the distal side relative to the J4 axis, as the current hand.

In the case where the control section 20 decides the first hand 12 as the current hand (FIG. 8(a)), when the operator manipulates the teaching pendant 23, the first hand 12 (or current hand) will be moved, based on the tool coordinate system, defined on the basis (or origin) of the center 12c of the first hand 12. Contrary, in the case where the control section 20 decides the second hand 13 as the current hand (FIG. 8(b)), when the operator utilizes the teaching pendant 23, the second hand 13 (or current hand) will be moved, base on the tool coordinate system, defined on the basis (origin) of the center 13c of the second hand 13.

As described above, the control section 20 can automatically judge that either hand is to be the current hand. Accordingly, in this embodiment, the mode in which the control section 20 can automatically judge the current hand and the mode in which the operator manually decides that either of the two hands 12, 13 is to be operated, without the judgment due to the control section 20, can be optionally switched relative to each other. This switching can be achieved, for example, due to manipulation of the teaching pendant 23.

As described above, according to this embodiment, since the current hand can be moved along the X axis, Y axis and C axis of the tool coordinate system defined on the basis of the center of the current hand, collisions of the remaining one of the two hands 12, 13, which is not intended to operate, with surrounding structures by mistake can be prevented, upon the manually guided operation.

### Coordinate Transformation from the Articulation Coordinate System to the Tool Coordinate System

Next, the coordinate transformation from the articulation coordinate system (comprising the J1 axis, J2 axis, J3 axis, J4 axis and J5 axis) into the tool coordinate system (comprising the X axis, Y axis, Z axis and C axis) will be described for the first to third embodiments.

Utilizing the teaching pendant 23, an operator can store various data in the internal memory 22 of the control section 20 and edit the data stored. As the data, the following ones can be mentioned.

### (Sigmoid Adjustable-Speed Operation Parameters)

With respect to a function for editing sigmoid adjustable-speed parameters for the manually guided operation based on the tool coordinate system, the following parameters can be edited and set.

### (1) A maximum speed (Vs), a maximum acceleration (As), and another maximum acceleration (Tas), for each translational motion (X axis, Y axis, Z axis).

### (2) A maximum speed (Vr), a maximum acceleration (Ar), and another maximum acceleration (Tar), for the rotational motion (C axis).

### (Offset Amount Parameters)

With respect to a function for editing and selecting the work offset table, the following parameters can be edited and set.

### (1) A data table for the offset amounts (X, Y) from the position of the center 12c (or center 13c) of the first hand 12 (or second hand 13) to the position of the center 14c of the work 14.

In addition, the teaching pendant 23 has the following functions.

### (1) A function for switching the coordinate systems (the articulation coordinate system/the tool coordinate system) for the robot body 11 of the control section 20, due to a “coordinate system selecting key” of the teaching pendant 23.

(2) A function for sending an operation start command, directed to a designated direction based on the tool coordinate system, from the teaching pendant 23 to the operation control section 21, when “manually guided keys (±X, ±Y, ±Z, ±C)” of the teaching pendant 23 are pushed.

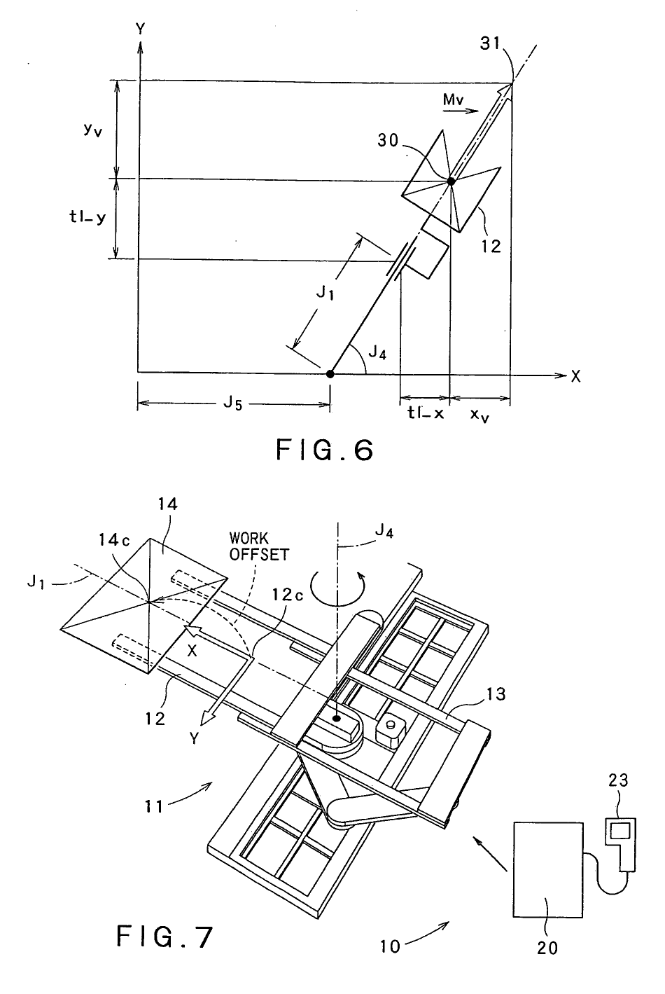

Next, a method of transforming the articulation coordinate system into the tool coordinate system in such a manner will be described in detail, with reference to FIG. 6.

First, the sigmoid adjustable-speed operation parameters for manual guidance based on the aforementioned tool coordinate system are retrieved, and stored in the internal memory 22. As the parameters, the maximum speed (Vs), maximum acceleration (As) and maximum acceleration (Tas) for each translational motion (X axis, Y axis, Z axis), and the maximum speed (Vr), maximum acceleration (Ar) and maximum acceleration (Tar) for the rotational motion (C axis), can be mentioned.

Subsequently, the offset amount parameters of the work 14 are transformed into the world coordinate system (ti-x, ti-y), based on the work offset table described above, and stored in the internal memory 22.

Thereafter, the current hand is decided. Namely, in the articulation coordinate system, when the value of J1 is larger than the value of J2 (J1>J2), the first hand 12 is decided to be the current hand. Contrary, when the value of J1 is smaller than the value of J2 (J1<J2), the second hand 13 is decided as the current hand. Moreover, when the value of J1 is equal to the value of J2 (J1=J2), the current hand is undecided.

Next, the operation control section 21 receives the operation start command from the teaching pendant 23, and calculates a movement vector oriented in the following designated direction.

[symbol]

v=(xᵥ,yᵥ,zᵥ,cᵥ) (Equation 1)

Thereafter, the operation control section 21 calculates a start position in the world coordinate system “Wₛ=(xₛ, yₛ, zₛ, cₛ)”, by performing sequential coordinate transformation for the start position in the articulation coordinate system “Jₛ=(Jₛ₁, Jₛ₂, Jₛ₃, Jₛ₄)” (designated by reference numeral 30 in FIG. 6). This method will be described below in more detail.

### (Sequential Coordinate Transformation)

### (In the Case Wherein the First Hand 12 is the Current Hand)

In this case, the start position in the world coordinate system “Wₛ=(xₛ, y_{s, z}ₛ, cₛ)” is calculated as follows.

xₛ=Jₛ₅+Jₛ₁·cos(Jₛ₄)+tl−x

yₛ=Jₛ₁·sin(Jₛ₄)+tl−y

zₛ=Jₛ₃

cₛ=Jₛ₄

### (In the Case Wherein the Second Hand 13 is the Current Hand)

In this case, the start position in the world coordinate system “Wₛ=(xₛ, yₛ, zₛ, cₛ)” is calculated as follows.

xₛ=Jₛ₅+Jₛ₂·cos(Jₛ₄)+tl−x

yₛ=Jₛ₂·sin(Jₛ₄)+tl−y

zₛ=Jₛ₃

cₛ=Jₛ₄

The operation control section 21 calculates a target position in the world coordinate system “Wₜ=(xₜ, yₜ, zₜ, cₜ)” (the following equation).

Wt=Ws+ [symbol] v (Equation 2)

Subsequently, the operation control section 21 produces a sigmoid adjustable-speed orbit to be defined from the start position in the world coordinate system “Wₛ=(xₛ, yₛ, zₛ, cₛ)” to the target position in the world coordinate system “Wₜ=(xₜ, yₜ, zₜ, cₜ)”, based on the aforementioned sigmoid adjustable-speed parameters (the maximum speed (Vs), maximum acceleration (As) and maximum acceleration (Tas) for each translational motion (X axis, Y axis, Z axis), and the maximum speed (Vr), maximum acceleration (Ar) and maximum acceleration (Tar) for the rotational motion (C axis)) stored in the internal memory 22.

Thereafter, the operation control section 21 calculates a distribution target position in the world coordinate system per unit time “Wₜᵤ=(xₜᵤ, yₜᵤ, zₜᵤ, cₜᵤ)”, and performs inverted coordination transformation for each component of the “Wₜᵤ=(xₜᵤ, yₜᵤ, zₜᵤ, cₜᵤ)”, so as to obtain a distribution target position in the articulation coordinate system “Jₜᵤ=(Jₜᵤ₁, Jₜᵤ₂, Jₜᵤ₃, Jₜᵤ₄, Jₜᵤ₅)”. This method will be described below in more detail.

### (Inverted Coordination Transformation)

### (In the Case Wherein the First Hand 12 is the Current Hand)

In this case, the start position in the world coordinate system “Jₜᵤ=(Jₜᵤ₁, Jₜᵤ₂, Jₜᵤ₃, Jₜᵤ₄, Jₜᵤ₅)” is calculated as follows.

Jₜᵤ₁=(yₜᵤ−tl−y)/sin(Jₜᵤ₄)

Jₜᵤ₂=Jₛ₂

Jₜᵤ₃=zₜᵤ₃

Jₜᵤ₄=cₜᵤ₄

Jₜᵤ₅=xₜᵤ−tl−x−Jₜᵤ₂·cos(Jₜᵤ₄)

### (In the Case Wherein the Second Hand 13 is the Current Hand)

In this case, the start position in the world coordinate system “Wₛ=(xₛ, yₛ, zₛ, cₛ)” is calculated as follows.

Jₜᵤ₁=Jₛ₁

Jₜᵤ₂=(yₜᵤ−tl−y)/sin(Jₜᵤ₄)

Jₜᵤ₃=zₜᵤ₃

Jₜᵤ₄=cₜᵤ₄

Jₜᵤ₅=xₜᵤ−tl−x−Jₜᵤ₂·cos(Jₜᵤ₄)

Subsequently, the operation control section 21 send the start position in the world coordinate system, “Jₜᵤ=(Jₜᵤ₁, Jₜᵤ₂, Jₜᵤ₃, Jₜᵤ₄, Jₜᵤ₅)”, calculated as described above, to the servo-control section.

In response to the command, the robot body 11 will be operated in accordance with the operation mode as described above.

1. A robot system including a robot body and a control section for controlling the robot body, the robot body comprising:
a first hand and a J1 axis, a J3 axis, a J4 axis, and a J5 axis along which the robot body is driven, wherein;
the J1 axis is an axis along which the first hand is moved in a direction from a proximal end of the first hand to its distal end;
the J4 axis is an axis about which the J1 axis is rotated in a horizontal plane;
the J3 axis is an axis along which the J4 axis is shifted in the vertical direction; and
the J5 axis is an axis along which the J3 axis is shifted in a direction in a horizontal plane,
wherein the J1 axis, J3 axis, J4 axis and J5 axis are synchronously driven by the control section, whereby the first hand can be moved on the X axis, Y axis and C axis in a tool coordinate system, on the basis of the center of the first hand.

2. A robot system including a robot body and a control section for controlling the robot body, the robot body comprising:
a first hand;
a second hand constituting a pair together with the first hand;
and a J1 axis, a J2 axis, a J3 axis, a J4 axis, and a J5 axis along which the robot body is driven, wherein;
the J1 axis and the J2 axis are axes along which the first hand and the second hand are moved in predetermined directions, from proximal ends to distal ends of these hands, respectively;
the J4 axis is an axis about which the J1 axis and J2 axis are rotated in a horizontal plane, respectively;
the J3 axis is an axis along which the J4 axis is shifted in the vertical direction; and
the J5 axis is an axis along which the J3 axis is shifted in a direction in a horizontal plane,
wherein the J1 axis, J2 axis, J3 axis, J4 axis and J5 axis are synchronously driven by an operational signal sent from the control section, whereby the first hand and second hand can be moved on the X axis, Y axis and C axis in a tool coordinate system, on the basis of the centers of the first hand and second hand, respectively.

3. The robot system according to claim 2, wherein either one of the first hand and second hand, which is located on the distal side relative to the J4 axis, is decided as a current hand, and wherein the decided current hand is moved along the X axis, Y axis and C axis in a tool coordinate system, on the basis of the center of the current hand.

4. The robot system according to claim 2, wherein the control section has a function to switch a usual articulation coordinate system mode for the J1 axis, J2 axis, J3 axis, J4 axis and J5 axis and the tool coordinate system mode defined on the basis of the centers of the hands.

5. The robot system according to claim 1, wherein the control section has an adjustment function to adjust the tool coordinate system when the center of the hand is offset from the center of a work.

6. The robot system according to claim 5, wherein the tool coordinate system is adjusted, based on data concerning the offset amount of the work, the data being registered, in advance, in the control section.

7. The robot system according to claim 3, wherein the control section includes an operational mode in which it automatically decides which is to be the current hand, among the first hand and second hand.

8. The robot system according to claim 2, wherein the first hand and second hand carry a work comprising a glass substrate, respectively.

9. The robot system according to claim 2, wherein the J1 axis and J2 axis are located on a same straight line in the XY plane of a fixed coordinate system, when viewed above the robot body.

10. The robot system according to claim 9, wherein the first hand is located above the second hand.

11. The robot system according to claim 2, wherein the control section has an adjustment function to adjust the tool coordinate system when the center of the hand is offset from the center of a work.
